(19) United States
(12) Patent Application Publication
(10) Pub. No.: US 2014/0186607 A1
(43) Pub. Date: Jul. 3, 2014

(54) ADHESIVE COMPOSITION FOR A SEMICONDUCTOR, ADHESIVE FILM PREPARED FROM THE COMPOSITION, AND SEMICONDUCTOR DEVICE CONNECTED BY THE FILM

(71) Applicants: Kyoung Tae WI, Uiwang-si (KR); Jae Won CHOI, Uiwang-si (KR); Sung Min KIM, Uiwang-si (KR); Jin Man KIM, Uiwang-si (KR); Hye Jin KIM, Uiwang-si (KR); Jun Woo LEE, Uiwang-si (KR)

(72) Inventors: Kyoung Tae WI, Uiwang-si (KR); Jae Won CHOI, Uiwang-si (KR); Sung Min KIM, Uiwang-si (KR); Jin Man KIM, Uiwang-si (KR); Hye Jin KIM, Uiwang-si (KR); Jun Woo LEE, Uiwang-si (KR)

(21) Appl. No.: 14/148,886

(22) Filed: Jan. 7, 2014

(30) Foreign Application Priority Data
Dec. 28, 2012 (KR) 10-2012-0156441
May 29, 2013 (KR) 10-2013-0060768

(51) Int. Cl. C09J 163/00

(52) U.S. Cl. CPC C09J 163/00
USPC 428/220; 523/400; 428/414

(57) ABSTRACT

An adhesive film, an adhesive composition, and a semiconductor device wherein, in the adhesive film, a difference between a storage modulus (A) of the adhesive film after 4 cycles and a storage modulus (B) of the adhesive film after 1 cycle is about 3×10⁶ dyne/cm² or less, the storage modulus (A) of the adhesive film after 4 cycles is about 7×10⁶ dyne/cm² or less, and the storage modulus (B) of the adhesive film after 1 cycle is about 2×10⁶ dyne/cm² or more, when curing at 125° C. for 1 hour and then at 150° C. for 10 minutes is defined as 1 cycle.

### CROSS-REFERENCE TO RELATED APPLICATION

Korean Patent Application No. 10-2013-0060768, filed on May 29, 2013, in the Korean Intellectual Property Office, and entitled: “Adhesive Composition For Semiconductor, Adhesive Film Comprising The Same, and Semiconductor Device Connected By The Film,” is incorporated by reference herein in its entirety.

### BACKGROUND

### 1. Field

Embodiments relate to an adhesive composition for a semiconductor, an adhesive film prepared from the composition, and a semiconductor device connected by the film.

### SUMMARY

Embodiments are directed to an adhesive composition for a semiconductor, an adhesive film prepared from the composition, and a semiconductor device connected by the film.

The embodiments may be realized by providing an adhesive film for semiconductors, wherein a difference between a storage modulus (A) of the adhesive film after 4 cycles and a storage modulus (B) of the adhesive film after 1 cycle is about 3×10⁶ dyne/cm² or less, the storage modulus (A) of the adhesive film after 4 cycles is about 7×10⁶ dyne/cm² or less, and the storage modulus (B) of the adhesive film after 1 cycle is about 2×10⁶ dyne/cm² or more, when curing at 125° C. for 1 hour and then at 150° C. for 10 minutes is defined as 1 cycle.

The adhesive film may have a die-shear strength of about 1 kgf/5×5 mm² chip or more at 260° C. after curing in an oven at 175° C. for 1 hour.

The adhesive film may have a void area ratio of about 10% or less after 4 cycles.

The adhesive film may have a haze value of about 20% or more.

The adhesive film may include a colorant filler.

The adhesive film may include an adhesive layer having a thickness of about 5 μm to about 15 μm.

The adhesive film may be used to attaching a chip to a PCB (printed circuit board) or attaching two chips different in size each other.

The adhesive layer may include a thermoplastic resin, an epoxy resin, a phenolic curing agent, an amine curing agent, a curing accelerator, and a colorant filler.

The adhesive layer may include about 51 wt % to about 80 wt % of the thermoplastic resin; about 5 wt % to about 20 wt % of the epoxy resin; about 2 wt % to about 10 wt % of the phenolic curing agent; about 2 wt % to about 10 wt % of the amine curing agent; about 0.1 wt % to about 10 wt % of the curing accelerator; and about 0.05 wt % to about 5 wt % of the colorant filler, all wt % being based on a total weight of the adhesive film in terms of solid content.

A weight ratio of a weight of the thermoplastic resin to a weight of a mixture of the epoxy resin, the phenolic curing agent, and the amine curing agent may be about 51-80:9-40.

The embodiments may also be realized by providing an adhesive composition for semiconductors, the adhesive composition including a thermoplastic resin, an epoxy resin, a phenolic curing agent, an amine curing agent, a curing accelerator, and a colorant filler.

A weight ratio of a weight of the thermoplastic resin to a weight of a mixture of the epoxy resin, the phenolic curing agent, and the amine curing agent may be about 51-80:9-40.

The amine curing agent may be an aromatic amine curing agent.

The aromatic amine curing agent may be represented by Formula 1, below,

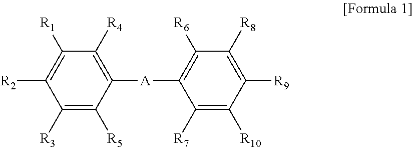

wherein, in Formula 1 A is a single bond or is selected from the group of —CH₂—, —CH₂CH₂—, —SO₂—, —NHCO—, —C(CH₃)₂—, and —O—; and R₁ to R₁₀ are each independently selected from hydrogen, a C₁-C₄ alkyl group, a C₁-C₄ alkoxy group, or an amine group, provided that at least two of R₁ to R₁₀ are amine groups.

The phenolic curing agent may be represented by Formula 6, below,

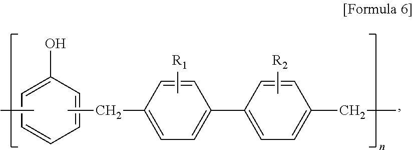

wherein, in Formula 6, R₁ and R₂ are each independently a C₁-C₆ alkyl group and n is about 2 to about 100.

The curing accelerator may include at least one of an imidazole curing accelerator or a microcapsule type latent curing agent.

The colorant filler may be an inorganic or organic pigment of a red, blue, green, yellow, violet, orange, brown, or black color.

The embodiments may also be realized by providing a semiconductor device connected using the adhesive film for semiconductors according to an embodiment.

### BRIEF DESCRIPTION OF DRAWING

Features will be apparent to those of skill in the art by describing in detail exemplary embodiments with reference to the attached drawings in which:

FIG. 1 illustrates a side sectional view of a semiconductor device in which a semiconductor chip is disposed on an adhesive layer for a primary compression process after the pre-compression process, with a base film removed from the anisotropic conductive film.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. In addition, it will also be understood that when a layer is referred to as being “between” two layers, it can be the only layer between the two layers, or one or more intervening layers may also be present. Like reference numerals refer to like elements throughout.

An embodiment may provide an adhesive film for semiconductors. In an implementation, a difference between a storage modulus (A) of the adhesive film after 4 cycles and a storage modulus (B) of the adhesive film after 1 cycle may be about 3×10⁶ dyne/cm² or less, when curing at 125° C. for 1 hour and 150° C. for 10 minutes is defined as 1 cycle. In an implementation, the storage modulus (A) of the adhesive film after 4 cycles may be about 7×10⁶ dyne/cm² or less. In an implementation, the storage modulus (B) of the adhesive film after 1 cycle may be about 2×10⁶ dyne/cm² or more. In an implementation, the difference between the storage modulus (A) of the adhesive film after 4 cycles and the storage modulus (B) of the adhesive film after 1 cycle may be about 2×10⁶ dyne/cm² or less.

The adhesive film for semiconductors may include an adhesive layer. In an implementation, the adhesive film for semiconductors may further include a base film. Accordingly, as used herein, the term “adhesive film for semiconductors” may refer to a “adhesive layer” without the base film.

Maintaining the difference between the storage modulus (A) of the adhesive film after 4 cycles and the storage modulus (B) of the adhesive film after 1 cycle at about 3×10⁶ dyne/cm² or less may help secure sufficient flowability for repeated heating cycles upon multilayer stacking. Maintaining a storage modulus (A) of the adhesive film after 4 cycles at about 7×10⁶ dyne/cm² or less may help ensure that voids are efficiently removed upon molding. Maintaining the storage modulus (B) of the adhesive film after 1 cycle at about 2×10⁶ dyne/cm² or more may help shorten the curing process (or semi-curing process or B-stage process) upon bonding after the chip bonding process.

The storage modulus may be measured by the following method.

A plurality of adhesive films for semiconductors may be stacked at 60° C. and cut into a circular sample having a diameter of 8 mm (thickness: about 400 μm to 450 μm). Then, the sample may be subjected to curing in an oven at 125° C. for 1 hour and on a hot plate at 150° C. for 10 minutes (i.e., 1 cycle), followed by measurement with a rheometer (ARES). After performing this cycle four times (i.e., 4 cycles), measurement with the rheometer was performed. The measurement was performed while increasing the temperature from 30° C. to 200° C. at a heating rate of 30° C./minute.

In order to be applicable to multilayer stacking, the adhesive composition or adhesive film may have a rapid curing rate and may secure sufficient flowability with low viscosity and storage modulus, even when subjected to repeated heating cycles. Generally, curing rate may be inversely proportional to generation of voids. For example, a higher curing rate may provide inefficient removal of voids. For example, upon multilayer stacking, a lowermost adhesive film layer may exhibit insufficient void removal characteristics due to curing through repeated heating cycles.

In the adhesive film for semiconductors according to an embodiment, the difference between the storage modulus (A) of the adhesive film after 4 cycles and the storage modulus (B) of the adhesive film after 1 cycle may be about 3×10⁶ dyne/cm² or less. In an implementation, the storage modulus (A) of the adhesive film after 4 cycles may be about 7×10⁶ dyne/cm² or less and/or the storage modulus (B) of the adhesive film after 1 cycle may be 2×10⁶ dyne/cm² or more. Accordingly, the adhesive film may be applied to an in-line process by exhibiting sufficient adhesion within a short curing time and may achieve efficient removal of voids upon a molding process by securing sufficient flowability for repeated heating cycles upon multilayer stacking.

According to an embodiment, the adhesive film for semiconductors may have a die-shear strength of about 1 kgf/5×5 mm² chip or more at 260° C. after 1 cycle. In an implementation, the adhesive film for semiconductors may have a die-shear strength of about 2 kgf/5×5 mm² chip or more. Maintaining the die-shear strength at about 1 kgf/5×5 mm² chip or more under these conditions may help prevent bonding failure due to chip movement upon wire bonding, and may help prevent chip failure caused by fillers penetrating into a vulnerable interface between chips and the adhesive film.

According to an embodiment, the adhesive film for semiconductors may have a void area of about 10% or less after 4 cycles. The void area may be measured as follows: the adhesive film for semiconductors is mounted on an 80 μm thick wafer, and cut into a specimen having a size of 10 mm×10 mm. Then, the specimen may be attached to a PCB at 120° C. and 1 kgf/1 sec, and subjected to curing in an oven at 125° C. for 1 hour and on a hot plate at 150° C. for 10 minutes (1 cycle). This cycle may be repeated four times to apply heat for 4 cycles, followed by molding using EMC (8500BCA, Cheil Industries, Inc.) at 175° C. for 120 seconds. The adhesive layer of the adhesive film may be exposed and photographed using a microscope (magnification: 25×), and the presence of voids may be inspected through image analysis. To digitize the number of voids, a lattice counting method may be used. For example, a total area of the sample may be divided into 10 lattice rows and 10 lattice columns, and the number of lattices including voids may be counted and converted into % (void area ratio).

Void area ratio=(void area/total area)×100

In the adhesive film for semiconductors according to an embodiment, the adhesive layer may have a haze value of about 20% or more. In the adhesive film for semiconductors, the adhesive layer may have a thickness of about 5 μm to about 15 μm, e.g., about 7 μm to about 12 μm or about 10 μm. Herein, the thickness of the adhesive layer may not include the thickness of a photo-sensitive adhesive layer or a thickness of the base film. A haze value of about 20% or more may relate to improvement in equipment recognition of the adhesive layer.

For example, the haze value may indicate a percentage of diffusive light to total light transmittance (transmitted light+diffusive light) of the adhesive layer as measured using a Halogen lamp.

Another embodiment relates to an adhesive composition or adhesive film for semiconductors. The adhesive composition or adhesive film may include, e.g., a thermoplastic resin, an epoxy resin, a phenolic curing agent, an amine curing agent, a curing accelerator, and colorant fillers.

In an implementation, the adhesive composition or adhesive film for semiconductors may include, e.g., (a) about 51 wt % to about 80 wt % of a thermoplastic resin, (b) about 5 wt % to about 20 wt % of an epoxy resin, (c) about 2 wt % to about 10 wt % of a phenolic curing agent, (d) about 2 wt % to about 10 wt % of an amine curing agent, (e) about 0.1 wt % to about 10 wt % of a curing accelerator, and (f) about 0.05 wt % to about 5 wt % of colorant fillers, based on a total weight of the adhesive composition or adhesive film.

In the adhesive composition or adhesive film, a weight ratio of the (a) thermoplastic resin to a curing system, e.g., a mixture of the (b) epoxy resin, the (c) phenolic curing agent and the (d) amine curing agent ((a):(b)+(c)+(d)) may be about 51-80:9-40.

In an implementation, the amine curing agent may be, e.g., an aromatic amine curing agent. For example, the amine curing agent may include an aromatic amine curing agent represented by Formula 1, below.

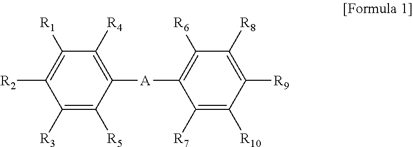

In Formula 1, A may be a single bond or may be selected from the group of —CH₂—, —CH₂CH₂—, —SO₂—, —NHCO—, —C(CH₃)₂—, and —O—. R₁ to R₁₀ may each independently be selected from among hydrogen, a C₁-C₄ alkyl group, a C₁-C₄ alkoxy group, or an amine group. In an implementation, at least two of R₁ to R₁₀ may be amine groups.

The phenolic curing agent may include a biphenyl group in a main chain. In an implementation, the phenolic curing agent may have a structure represented by Formula 6, below.

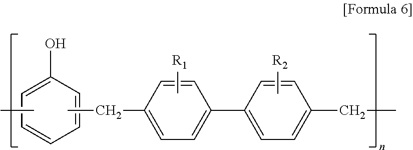

In Formula 6, R₁ and R₂ may each independently be a C₁-C₆ alkyl group, and n may be about 2 to about 100.

In an implementation, the curing accelerator may be an imidazole type curing agent or a microcapsule type latent curing agent. In an implementation, the curing accelerator may be, e.g., a microcapsule type latent curing agent.

Examples of imidazole curing accelerators may include 2-methylimidazole, 2-ethyl-4-methylimidazole, 2-undecylimidazole, 2-heptadecylimidazole, 2-phenylimidazole, 2-phenyl-4-methylimidazole, 1-benzyl-2-methylimidazole, 2-ethylimidazole, 2-isopropylimidazole, 2-phenyl-4-benzylimidazole, 2-phenyl-4,5-dihydroxymethylimidazole, 2-phenyl-4-methyl-5-hydroxymethylimidazole, 2-phenyl-4-benzyl-5-hydroxymethylimidazole, 4-4′-methylenebis-(2-ethyl-5-methylimidazole), 2-aminoethyl-2-methylimidazole, 1-cyanoethyl-2-phenyl-4,5-di(cyanoethoxymethyl)imidazole, and the like. Examples of commercially available imidazole curing accelerators may include 2MZ, 2E4MZ, C11Z, C17Z, 2PZ, 2PZ-CN, 2P4MZ, 1B2MZ, 2EZ, 2IZ, 2P4BZ, 2PH2-PW, 2P4 MHZ, 2P4BHZ, 2E4MZ-BIS, AMZ, 2PHZ-CN, and the like (Asahi Kasei Corporation). In an implementation, 2-phenyl-4,5-dihydroxymethylimidazole or 2-phenyl-4-methylimidazole may be used as the imidazole curing accelerator.

In an implementation, a suitable microcapsule type latent curing agent may be used. For example, the microcapsule type latent curing agent may include a microcapsule type latent curing agent in which a core includes amine adducts and a capsule includes a reaction product of a compound containing an isocyanate and an active hydrogen group and/or water; or a microcapsule curing agent in which a core contains an imidazole compound, and a shell contains an organic polymer, an inorganic compound, or both and covers the surface of the core. For example, Novacure® HX-3721, HX-3748, HX-3741, HX-3613, HX-3722, HX-3742, HX-3088, HX-3792, HX-3921HP, HX-4921HP, HX-3922HP, and HX-3932HP may be used. In an implementation, HX-3741, HX-3088, and HX-3792 may be used.

In an implementation, the adhesive composition or adhesive film for semiconductors may further include a silane coupling agent and/or fillers. In an implementation, the silane coupling agent may be present in an amount of about 0.01 wt % to about 5 wt %, and/or the fillers may be present in an amount of about 5 wt % to about 20 wt %, based on the weight of the adhesive composition or film.

Next, each component of the adhesive composition for semiconductors, e.g., the thermoplastic resin, the epoxy resin, the phenolic curing agent, the amine curing agent, the curing accelerator, and the colorant fillers, will be described in detail.

### Thermoplastic Resin

Examples of thermoplastic resins may include polyimide resins, polystyrene resins, polyethylene resins, polyester resins, polyamide resins, butadiene rubbers, acryl rubbers, (meth)acrylate resins, urethane resins, polyphenylene ether resins, polyether imide resins, phenoxy resins, polycarbonate resins, polyphenylene ether resins, modified polyphenylene ether resins, and mixtures thereof. In an implementation, the thermoplastic resin may include an epoxy group. In an implementation, an epoxy group-containing (meth)acrylic copolymer may be used as the thermoplastic resin.

The thermoplastic resin may have a glass transition temperature of about −30° C. to about 80° C., e.g., about 5° C. to about 60° C. or about 5° C. to about 35° C. Within this range, the adhesive composition may secure high flowability to exhibit excellent void removal capability, and may provide high adhesion and reliability.

In an implementation, the thermoplastic resin may have a weight average molecular weight of about 50,000 g/mol to about 5,000,000 g/mol.

The thermoplastic resin may be present in an amount of about 51 wt % to about 80 wt %, e.g., about 55 wt % to about 75 wt % or about 60 wt % to about 72 wt %, based on the total weight of the adhesive composition in terms of solid content. Maintaining the amount of the thermoplastic resin at about 51 wt % or greater may help ensure good properties with respect to void generation and reliability.

The weight ratio of the thermoplastic resin (A) to a mixture of the epoxy resin (B), the phenolic curing agent (C), and the amine curing agent (D), as a curing system, e.g., the weight ratio of (A):(B)+(C)+(D), may be about 51˜80 (parts by weight): 9˜40 (parts by weight), e.g., about 55˜75 (parts by weight): 15˜30 (parts by weight). Within this range of the weight ratio, void generation may be advantageously suppressed.

### Epoxy Resin

The epoxy resin may be curable, and may function to impart adhesion to the composition. The epoxy resin may be, e.g., a liquid epoxy resin, a solid epoxy resin, or a mixture thereof.

Examples of suitable liquid epoxy resins may include bisphenol A type liquid epoxy resins, bisphenol F type liquid epoxy resins, tri- or higher polyfunctional liquid epoxy resins, rubber-modified liquid epoxy resins, urethane-modified liquid epoxy resins, acrylic modified liquid epoxy resins, and photosensitive liquid epoxy resins. These liquid epoxy resins may be used alone or as a mixture. For example, a bisphenol A type liquid epoxy resin may be used.

The liquid epoxy resin may have an epoxy equivalent weight of about 100 g/eq. to about 1,500 g/eq. In an implementation, the liquid epoxy resin may have an epoxy equivalent weight of about 150 g/eq. to about 800 g/eq., e.g., about 150 g/eq. to about 400 g/eq. Within this range, a cured product with good adhesion and heat resistance may be obtained, while maintaining the glass transition temperature.

The liquid epoxy resin may have a weight average molecular weight of about 100 g/mol to about 1,000 g/mol. Within this range of molecular weight of the liquid epoxy resin, the composition may exhibit excellent flowability.

The solid epoxy resin may be one that is a solid or quasi-solid at room temperature and has mono- or higher functional groups. The solid epoxy resin may have a softening point (Sp) of about 30° C. to about 100° C. Examples of suitable solid epoxy resins may include bisphenol epoxy resins, phenol novolac epoxy resins, o-cresol novolac epoxy resins, polyfunctional epoxy resins, amine epoxy resins, heterocyclic epoxy resins, substituted epoxy resins, naphthol-based epoxy resins, biphenyl-based epoxy resins, and derivatives thereof.

As commercially available solid epoxy resins, examples of bisphenol epoxy resins may include YD-017H, YD-020, YD020-L, YD-014, YD-014ER, YD-013K, YD-019K, YD-019, YD-017R, YD-017, YD-012, YD-011H, YD-011S, YD-011, YDF-2004, YDF-2001 (Kukdo Chemical Co., Ltd.), and the like. Examples of phenol novolac epoxy resins may include EPIKOTE 152 and EPIKOTE 154 (Yuka Shell Epoxy Co., Ltd.); EPPN-201 (Nippon Kayaku Co., Ltd.); DN-483 (Dow Chemical Company); YDPN-641, YDPN-638A80, YDPN-638, YDPN-637, YDPN-644, YDPN-631 (Kukdo Chemical Co., Ltd.), and the like. Examples of o-cresol novolac epoxy resins may include: YDCN-500-1P, YDCN-500-2P, YDCN-500-4P, YDCN-500-5P, YDCN-500-7P, YDCN-500-8P, YDCN-500-10P, YDCN-500-80P, YDCN-500-80PCA60, YDCN-500-80PBC60, YDCN-500-90P, YDCN-500-90PA75 (Kukdo Chemical Co., Ltd.); EOCN-102S, EOCN-103S, EOCN-104S, EOCN-1012, EOCN-1025, EOCN-1027 (Nippon Kayaku Co., Ltd.); YDCN-701, YDCN-702, YDCN-703, YDCN-704 (Tohto Kagaku Co., Ltd.); Epiclon N-665-EXP (Dainippon Ink and Chemicals, Inc.), and the like. Examples of bisphenol novolac epoxy resins may include KBPN-110, KBPN-120, KBPN-115 (Kukdo Chemical Co., Ltd.), and the like. Examples of polyfunctional epoxy resins may include Epon 1031S (Yuka Shell Epoxy Co., Ltd.); Araldite 0163 (Ciba Specialty Chemicals Co., Ltd.); Detachol EX-611, Detachol EX-614, Detachol EX-614B, Detachol EX-622, Detachol EX-512, Detachol EX-521, Detachol EX-421, Detachol EX-411, Detachol EX-321 (NAGA Celsius Temperature Kasei Co., Ltd.); EP-5200R, KD-1012, EP-5100R, KD-1011, KDT-4400A70, KDT-4400, YH-434L, YH-434, YH-300 (Kukdo Chemical Co., Ltd.), and the like. Examples of amine epoxy resins include EPIKOTE 604 (Yuka Shell Epoxy Co., Ltd.); YH-434 (Tohto Kagaku Co., Ltd.); TETRAD-X and TETRAD-C (Mitsubishi Gas Chemical Company Inc.); ELM-120 (Sumitomo Chemical Industry Co., Ltd.), and the like. An example of a heterocyclic epoxy resin may include PT-810 (Ciba Specialty Chemicals). Examples of substituted epoxy resins may include: ERL-4234, ERL-4299, ERL-4221, ERL-4206 (UCC Co., Ltd.), and the like. Examples of naphthol epoxy resins may include: Epiclon HP-4032, Epiclon HP-4032D, Epiclon HP-4700, and Epiclon HP-4701 (Dainippon Ink and Chemicals, Inc.). Examples of non-phenolic epoxy resins may include YX-4000H (Japan Epoxy Resin), YSLV-120TE, GK-3207 (Nippon steel chemical), NC-3000 (Nippon Kayaku), and the like. These epoxy resins may be used alone or as mixtures.

The epoxy resin may be present in an amount of about 5 wt % to about 20 wt %, e.g., about 7 to about 15 wt %, based on the total weight of the adhesive composition in terms of solid content. Within this range, high reliability and excellent mechanical properties may be attained.

### Curing Agent

The curing agents suitable for use in the adhesive composition may include two kinds of curing agents having different reaction temperature zones.

In an implementation, the curing agents may include phenolic curing agent and amine curing agent.

Examples of phenolic curing agents may include: bisphenol resins containing two or more phenolic hydroxyl groups in a single molecule and exhibiting excellent electrolytic corrosion resistance upon hydrolysis, such as bisphenol A, bisphenol F, bisphenol S, and the like; phenol novolac resins; bisphenol A novolac resins; and phenolic resins such as xylene, cresol novolac, biphenyl resins, and the like. As commercially available phenolic curing agents, examples of phenolic curing agents may include H-1, H-4, HF-1M, HF-3M, HF-4M, and HF-45 (Meiwa Plastic Industries Co., Ltd.); examples of paraxylene phenolic curing agents may include MEH-78004S, MEH-7800SS, MEH-7800S, MEH-7800M, MEH-7800H, MEH-7800HH, and MEH-78003H (Meiwa Plastic Industries Co., Ltd.), PH-F3065 (Kolong Industries Co., Ltd.); examples of biphenyl curing agents may include MEH-7851SS, MEH-7851S, MEH-7851M, MEH-7851H, MEH-78513H, and MEH-78514H (Meiwa Plastic Industries Co., Ltd.), and KPH-F4500 (Kolong Industries Co., Ltd.); and examples of triphenylmethyl curing agents may include MEH-7500, MEH-75003S, MEH-7500SS, MEH-7500S, MEH-7500H (Meiwa Plastic Industries Co., Ltd.), and the like. These may be used alone or as mixtures thereof.

In an implementation, the phenolic curing agent in the adhesive composition may have a structure represented by Formula 6, below.

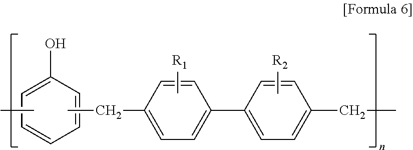

In Formula 6, R₁ and R₂ may each independently be a C₁-C₆ alkyl group, and n may be about 2 to about 100.

Examples of the phenolic curing agents may include MEH-7851SS, MEH-7851S, MEH-7851M, MEH-7851H and MEH-78514H, which are commercially available from Meiwa Plastic Industries Co., Ltd.

In an implementation, the phenolic curing agent may be present in an amount of about 2 wt % to about 10 wt %, based on the total weight of the adhesive composition in terms of solid content.

In an implementation, the amine curing agent may include an aromatic amine curing agent in view of curing rate adjustment. For example, the aromatic amine curing resin may be an aromatic compound having two or more amine groups. In an implementation, the aromatic amine curing agent may be an aromatic compound represented by, e.g., one of Formulae 1 to 5, below.

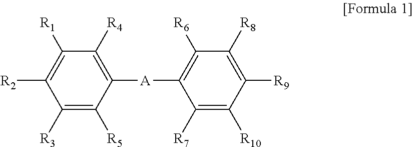

In Formula 1, A may be a single bond or may be selected from the group of —CH₂—, —CH₂CH₂—, —SO₂—, —NHCO—, —C(CH₃)₂—, and —O—. R₁ to R₁₀ may each independently be selected from among hydrogen, a C₁ to C₄ alkyl group, a C₁ to C₄ alkoxy group, and an amine group. In an implementation, at least two of R₁ to R₁₀ may be amine groups.

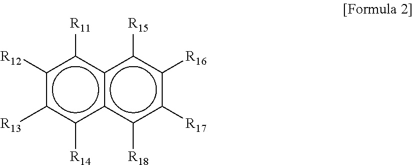

In Formula 2, R₁₁ to R₁₈ may each independently be selected from among a C₁ to C₄ alkyl group, an alkoxy group, a hydroxyl group, a cyanide group, an amine group, and a halogen. In an implementation, at least one of R₁₁ to R₁₈ may be an amine group.

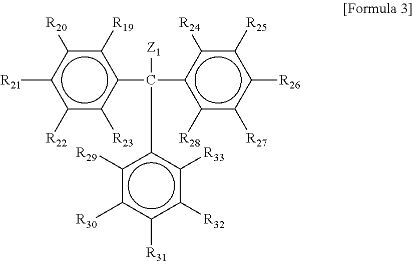

In Formula 3, Z₁ may be hydrogen, a C₁ to C₄ alkyl group, an alkoxy group, or a hydroxyl group. R₁₉ to R₃₃ may each independently be selected from among hydrogen, a C₁ to C₄ alkyl group or alkoxy group, a hydroxyl group, a cyanide group, an amine group, and a halogen. In an implementation, at least one of R₁₉ to R₃₃ may be an amine group.

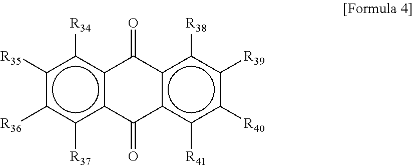

In Formula 4, R₃₄ to R₄₁ may each independently be selected from among hydrogen, a C₁ to C₄ alkyl group or alkoxy group, a hydroxyl group, a cyanide group, an amine group, and a halogen. In an implementation, at least one of R₃₄ to R₄₁ may be an amine group.

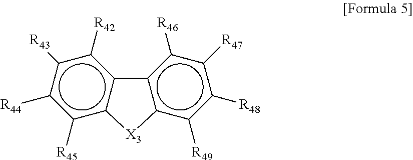

In Formula 5, X₃ may be selected from the group of —CH₂—, —NH—, —SO₂—, —S—, and —O—. R₄₂ to R₄₉ may each independently be selected from among hydrogen, a C₁ to C₄ alkyl group or alkoxy group, a hydroxyl group, a cyanide group, an amine group, and a halogen. In an implementation, at least one of R₄₂ to R₄₉ may be an amine group.

Examples of the curing agent represented by Formula 1 may include 3,3′-diaminobenzidine, 4,4′-diaminodiphenyl methane, 4,4′ or 3,3′-diaminodiphenyl sulfone, 4,4′-diaminobenzophenone, paraphenylene diamine, metaphenylene diamine, metatoluene diamine, 4,4′-diaminodiphenyl ether, 4,4′ or 3,3′-diaminobenzophenone, 1,4′ or 1,3′-bis(4 or 3-aminocumyl)benzene, 1,4′ bis(4 or 3-aminophenoxy)benzene, 2,2′-bis[4-(4 or 3-aminophenoxy)phenyl]propane, bis[4-(4 or 3-aminophenoxy)phenyl]sulfone, 2,2′-bis[4-(4 or 3-aminophenoxy)phenyl]hexafluorosulfone, 2,2′-bis[4-(4 or 3-aminophenoxy)phenyl]hexafluoropropane, 4,4′-diamino-3,3′,5,5′-tetrabutyldiphenylketone, 4,4′-diamino-3,3′,5,5′-tetraethyldiphenylketone, 4,4′-diamino-3,3′,5,5′-tetra-n-propylenediphenylketone, 4,4′-diamino-3,3′,5,5′-tetraisopropyldiphenylketone, 4,4′-diamino-3,3′,5,5′-tetramethyldiphenylketone, 4,4′-diamino-3,3′,5,5′-tetra-n-propyldiphenylmethane, 4,4′-diamino-3,3′5,5-tetramethyldiphenylmethane, 4,4′-diamino-3,3′5,5′-tetraisopropyldiphenylmethane, 4,4′-diamino-3,3′5,5′-tetraethyldiphenylmethane, 4,4′-diamino-3,3′-dimethyl-5,5′-diethyldiphenylmethane, 4,4′-diamino-3,3′-dimethyl-5,5′-diisopropyldiphenylmethane, 4,4′-diamino-3,3′-diethyl-5,5′-diethyldiphenylmethane, 4,4′-diamino-3,5′-dimethyl-3,5-diethyldiphenylmethane, 4,4′-diamino-3,5-dimethyl-3′,5′-diisopropyldiphenylmethane, 4,4′-diamino-3,5-diethyl-3′,5′-dibutyldiphenylmethane, 4,4′-diamino-3,5-diisopropyl-3′,5′-dibutyldiphenylmethane, 4,4′-diamino-3,3′-diisopropyl-5,5′-dibutyldiphenylmethane, 4,4′-diamino-3,3′-dimethyl-5′,5′-dibutyldiphenylmethane, 4,4′-diamino-3,3′-diethyl-5′,5′-dibutyldiphenylmethane, 4,4′-diamino-3,3′-dimethyldiphenylmethane, 4,4′-diamino-3,3′-diethyldiphenylmethane, 4,4′-diamino-3,3′-di-n-propyldiphenylmethane, 4,4′-diamino-3,3′-diisopropyldiphenylmethane, 4,4′-diamino-3,3′-dibutyldiphenylmethane, 4,4′-diamino-3,3′,5-trimethyldiphenylmethane, 4,4′-diamino-3,3′,5-triethyldiphenylmethane, 4,4′-diamino-3,3′,5-tri-n-propyldiphenylmethane, 4,4′-diamino-3,3′,5-triisopropyldiphenylmethane, 4,4′-diamino-3,3′,5-tributyldiphenylmethane, 4,4′-diamino-3-methyl-3′-ethyldiphenylmethane, 4,4′-diamino-3-methyl-3′-isopropyldiphenylmethane, 4,4′-diamino-3-methyl-3′-butyldiphenylmethane, 4,4′-diamino-3-isopropyl-3′-butyldiphenylmethane, 2,2-bis(4-amino-3,5-dimethylphenyl)propane, 2,2-bis(4-amino-3,5-diethylphenyl)propane, 2,2-bis(4-amino-3,5-di-n-propylphenyl)propane, 2,2-bis(4-amino-3,5-diisopropylphenyl)propane, 2,2-bis(4-amino-3,5-dibutylphenyl)propane, 4,4′-diamino-3,3′,5,5′-tetramethyldiphenylbenzanilide, 4,4′-diamino-3,3′,5,5′-tetraethyldiphenylbenzanilide, 4,4′-diamino-3,3′,5,5′-tetra-n-propyldiphenylbenzanilide, 4,4′-diamino-3,3′,5,5′-tetraisopropyldiphenylbenzanilide, 4,4′-diamino-3,3′,5,5′-tetrabutyldiphenylbenzanilide, 4,4′-diamino-3,3′,5,5′-tetramethyldiphenylsulfone, 4,4′-diamino-3,3′,5,5′-tetraethyldiphenylsulfone, 4,4′-diamino-3,3′,5,5′-tetra-n-propyldiphenylsulfone, 4,4′-diamino-3,3′,5,5′-tetraisopropyldiphenylsulfone, 4,4′-diamino-3,3′,5,5′-tetramethyldiphenylether, 4,4′-diamino-3,3′,5,5′-tetraethyldiphenylether, 4,4′-diamino-3,3′,5,5′-tetra-n-propyldiphenylether, 4,4′-diamino-3,3′,5,5′-tetraisopropyldiphenylether, 4,4′-diamino-3,3′,5,5′-tetrabutyldiphenylether, 3,3′-diaminobenzophenone, 3,4-diaminobenzophenone, 3,3′-diaminodiphenylether, 3,3′-diaminodiphenylmethane, 3,4′-diaminodiphenylmethane, 2,2′-diamino-1,2-diphenylethane or 4,4′-diamino-1,2-diphenylethane, 2,4-diaminodiphenylamine, 4,4′-diaminooctafluorobiphenyl, o-dianisidine, and the like.

Examples of the curing agent represented by Formula 2 may include 1,5-diaminonaphthalene, 1,8-diaminonaphthalene, 2,3-diaminonaphthalene, and the like. Examples of the curing agent represented by Formula 3 may include pararosaniline and the like. Examples of the curing agent represented by Formula 4 may include 1,2-diaminoanthraquinone, 1,4-diaminoanthraquinone, 1,5-diaminoanthraquinone, 2,6-diaminoanthraquinone, 1,4-diamino-2,3-dichloroanthraquinone, 1,4-diamino-2,3-dicyano-9,10-anthraquinone, 1,4-diamino-4,8-dihydroxy-9,10-anthraquinone, and the like. Examples of the curing agent represented by Formula 5 may include 3,7-diamino-2,8-dimethyldibenzothiphenesulfone, 2,7-diaminofluorene, 3,6-diaminocarbazole, and the like.

The amine curing resin may be present in an amount of about 2 wt % to about 10 wt %, based on the total weight of the adhesive composition in terms of solid content.

### Curing Accelerator

The adhesive composition for semiconductors may include a curing accelerator. The curing accelerator may help reduce curing time of the epoxy resin during a semiconductor process. Suitable curing accelerators may include, e.g., melamine, imidazole, or microcapsule type latent curing catalysts, or triphenylphosphine curing catalysts. In an implementation, imidazole or microcapsule type latent curing agents may be used. In an implementation, e.g., a microcapsule type latent curing agent may be used.

Examples of suitable imidazole curing accelerators may include 2-methylimidazole, 2-ethyl-4-methylimidazole, 2-undecylimidazole, 2-heptadecylimidazole, 2-phenylimidazole, 2-phenyl-4-methylimidazole, 1-benzyl-2-methylimidazole, 2-ethylimidazole, 2-isopropylimidazole, 2-phenyl-4-benzylimidazole, 2-phenyl-4,5-dihydroxymethylimidazole, 2-phenyl-4-methyl-5-hydroxymethylimidazole, 2-phenyl-4-benzyl-5-hydroxymethylimidazole, 4-4′-methylenebis-(2-ethyl-5-methylimidazole), 2-aminoethyl-2-methylimidazole, 1-cyanoethyl-2-phenyl-4,5-di(cyanoethoxymethyl)imidazole, and the like. Examples of commercially available imidazole curing accelerators may include 2MZ, 2E4MZ, C11Z, C17Z, 2PZ, 2PZ-CN, 2P4MZ, 1B2MZ, 2EZ, 2IZ, 2P4BZ, 2PH2-PW, 2P4 MHZ, 2P4BHZ, 2E4MZ-BIS, AMZ, and 2PHZ-CN (Asahi Kasei Corporation). In an implementation, 2-phenyl-4,5-dihydroxymethylimidazole or 2-phenyl-4-methylimidazole may be advantageously used as the imidazole curing accelerator.

Examples of suitable microcapsule type latent curing agents may include a microcapsule type latent curing agent in which a core includes amine adducts and a capsule includes a reaction product of a compound containing an isocyanate and an active hydrogen group and/or water; or a microcapsule curing agent in which a core contains an imidazole compound, and a shell contains an organic polymer, an inorganic compound, or both, and covers the surface of the core. For example, Novacure® HX-3721, HX-3748, HX-3741, HX-3613, HX-3722, HX-3742, HX-3088, HX-3792, HX-3921HP, HX-4921HP, HX-3922HP, and HX-3932HP may be used. Specifically, HX-3741, HX-3088, and HX-3792 may be used.

Examples of the phosphine-based curing catalyst may include TBP, TMTP, TPTP, TPAP, TPPO, DPPE, DPPP, and DPPB (HOKKO Chemical Industry Co., Ltd.).

The curing accelerator may be present in an amount of about 0.1 wt % to about 10 wt %, e.g., about 0.3 wt % to about 7 wt %, based on the total weight of the adhesive composition in terms of solid content. Within this range of the curing accelerator, the composition may exhibit high heat resistance, flowability, and connection performance, without rapid reaction of the epoxy resin.

### Colorant Fillers

The adhesive composition and/or the adhesive film for semiconductors may include a colorant filler. As the colorant filler, organic or inorganic pigments of red, blue, green, yellow, violet, orange, brown, or black color may be used. In terms of reliability, inorganic pigments may advantageously be used. In an implementation, examples of white inorganic pigments may include zinc oxide, titanium oxide, silver white, and the like, and examples of red inorganic pigments may include Bengala, vermilion, cadmium red, and the like. Examples of yellow inorganic pigments may include chromium yellow, red clay, cadmium yellow, and the like, and examples of green inorganic pigments may include emerald green, chromium oxide green, and the like. Examples of blue inorganic pigments may include Prussian blue, cobalt blue, and the like, and examples of violet inorganic pigment include manganese, manganese compounds or complexes, and the like. Examples of black pigments include carbon black, iron black, and the like. The colorant fillers may not contain a halogen element in terms of reduced environmental impact and negative influence on human health.

Suitable organic pigments may include the following pigments:

### Red Colorant Fillers

Examples of red colorants may include monoazo, disazo, azo lake, benzimidazolone, phenylene, diketopyrrolopyrrole, condensed azo, anthraquinone, quinacridone pigments, and the like. In an implementation, the red colorants may be pigments with color index (C.I., published by the Society of Dyers and Colourists) numbers as follows.

Monoazo pigments: Pigment red 1, 2, 3, 4, 5, 6, 8, 9, 12, 14, 15, 16, 17, 21, 22, 23, 31, 32, 112, 114, 146, 147, 151, 170, 184, 187, 188, 193, 210, 245, 253, 258, 266, 267, 268, 269.

Disazo pigments: Pigment red 37, 38, 41.

Monoazo lake pigments: Pigment red 48:1, 48:2, 48:3, 48:4, 49:1, 49:2, 50:1, 52:1, 52:2, 53:1, 53:2, 57:1, 58:4, 63:1, 63:2, 64:1, 68.

Benzimidazolone pigments: Pigment red 171, Pigment red 175, Pigment red 176, Pigment red 185, Pigment red 208.

Phenylene pigments: Solvent red 135, Solvent red 179, Pigment red 123, Pigment red 149, Pigment red 166, Pigment red 178, Pigment red 179, Pigment red 190, Pigment red 194, Pigment red 224.

Diketopyrrolopyrrole pigments: Pigment red 254, Pigment red 255, Pigment red 264, Pigment red 270, Pigment red 272.

Condensed azo pigments: Pigment red 220, Pigment red 144, Pigment red 166, Pigment red 214, Pigment red 220, Pigment red 221, Pigment red 242.

Anthraquinone pigments: Pigment red 168, Pigment red 177, Pigment red 216, Solvent red 149, Solvent red 150, Solvent red 52, Solvent red 207.

Quinacridone pigments: Pigment red 122, Pigment red 202, Pigment red 206, Pigment red 207, Pigment red 209.

### Blue Colorant Fillers

Examples of blue colorant fillers may include phthalocyanine colorants, anthraquinone colorants, and pigment compounds, such as Pigment blue 15, Pigment blue 15:1, Pigment blue 15:2, Pigment blue 15:3, Pigment blue 15:4, Pigment blue 15:6, Pigment blue 16, and Pigment blue 60.

As dyes compounds, Solvent blue 35, Solvent blue 63, Solvent blue 68, Solvent blue 70, Solvent blue 83, Solvent blue 87, Solvent blue 94, Solvent blue 97, Solvent blue 122, Solvent blue 136, Solvent blue 67, Solvent blue 70, and the like may be used. In an implementation, metal substituted or unsubstituted phthalocyanine compounds may be used.

### Green Colorant Fillers

Examples of green colorant fillers may include phthalocyanine, anthraquinone, and phenylene compounds. In an implementation, Pigment green 7, Pigment green 36, Solvent green 3, Solvent green 5, Solvent green 20, Solvent green 28, and the like may be used.

In an implementation, metal substituted or unsubstituted phthalocyanine compounds may be used.

### Yellow Colorant Fillers

Examples of yellow colorant fillers may include monoazo, diazo, condensed azo, benzimidazolone, isoindolinone, anthraquinone pigments, and the like. In an implementation, the yellow colorant fillers may be as follows.

Anthraquinone pigments: Solvent Yellow 163, Pigment Yellow 24, Pigment Yellow 108, Pigment Yellow 193, Pigment Yellow 147, Pigment Yellow 199, Pigment Yellow 202.

Isoindolinone pigments: Pigment Yellow 110, Pigment Yellow 109, Pigment Yellow 139, Pigment Yellow 179, Pigment Yellow 185.

Condensed azo pigments: Pigment Yellow 93, Pigment Yellow 94, Pigment Yellow 95, Pigment Yellow 128, Pigment Yellow 155, Pigment Yellow 166, Pigment Yellow 180.

Benzimidazolone pigments: Pigment Yellow 120, Pigment Yellow 151, Pigment Yellow 154, Pigment Yellow 156, Pigment Yellow 175, Pigment Yellow 181.

Monoazo pigments: Pigment Yellow 1, 2, 3, 4, 5, 6, 9, 10, 12, 61, 62, 62:1, 65, 73, 74, 75, 97, 100, 104, 105, 111, 116, 167, 168, 169, 182, 183.

Disazo pigments: Pigment Yellow 12, 13, 14, 16, 17, 55, 63, 81, 83, 87, 126, 127, 152, 170, 172, 174, 176, 188, 198.

In an implementation, violet, orange, brown, black colorant fillers may be used in order to adjust the color of the film.

For example, such colorant fillers for color adjustment of the film may include Pigment violet 19, 23, 29, 32, 36, 38, 42, Solvent violet 13, 36, C.I. Pigment orange 1, C.I. Pigment orange 5, C.I. Pigment orange 13, C.I. Pigment orange 14, C.I. Pigment orange 16, C.I. Pigment orange 17, C.I. Pigment orange 24, C.I. Pigment orange 34, C.I. Pigment orange 36, C.I. Pigment orange 38, C.I. Pigment orange 40, C.I. Pigment orange 43, C.I. Pigment orange 46, C.I. Pigment orange 49, C.I. Pigment orange 51, C.I. Pigment orange 61, C.I. Pigment orange 63, C.I. Pigment orange 64, C.I. Pigment orange 71, C.I. Pigment orange 73, C.I. Pigment brown 23, C.I. Pigment brown 25, C.I. Pigment black 1, C.I. Pigment black 7, or the like.

The colorant fillers may be present in an amount of about 0.05 wt % to about 5.0 wt %, based on the total weight of the adhesive composition or adhesive film for semiconductors in terms of solid content.

### Silane Coupling Agent

The adhesive composition for semiconductors may further include a silane coupling agent. The silane coupling agent may function as an adhesion promoter to enhance adhesion between the surface of an inorganic material, e.g., fillers, and the organic materials via chemical coupling therebetween during blending of the composition.

Examples of a suitable silane coupling agent may include: epoxy group-containing silane coupling agents, such as 2-(3,4-epoxycyclohexyl)-ethyltrimethoxysilane, 3-glycidoxytrimethoxysilane, and 3-glycidoxypropyltriethoxysilane; amine group-containing silane coupling agents, such as N-2-(aminoethyl)-3-aminopropylmethyldimethoxysilane, N-2-(aminoethyl)-3-aminopropyltrimethoxysilane, N-2-(aminoethyl)-3-aminopropyltriethoxysilane, 3-aminopropyltrimethoxysilane, 3-aminopropyltriethoxysilane, 3-triethoxysilyl-N-(1,3-dimethylbutylidene)propylamine and N-phenyl-3-aminopropyltrimethoxysilane; mercapto-containing silane coupling agents, such as 3-mercaptopropylmethyldimethoxysilane and 3-mercaptopropyltriethoxysilane; and isocyanate-containing silane coupling agents, such as 3-isocyanatepropyltriethoxysilane. These silane coupling agents may be used alone or as mixtures thereof.

The coupling agent may be present in an amount of about 0.01 wt % to about 5 wt %, e.g., about 0.1 wt % to about 3 wt % or about 0.5 wt % to about 2 wt %, based on the total weight of the adhesive composition in terms of solid content. Within this range of the coupling agent, the adhesive composition may obtain high adhesion reliability while reducing bubbling.

### Fillers

The composition may further include fillers. Examples of fillers may include: metal powders, such as gold, silver, copper and nickel powders; and nonmetal or metal compounds, such as alumina, aluminum hydroxide, magnesium hydroxide, calcium carbonate, magnesium carbonate, calcium silicate, magnesium silicate, calcium oxide, magnesium oxide, aluminum oxide, aluminum nitride, silica, boron nitride, titanium dioxide, glass, iron oxide, and ceramics. In an implementation, silica may be used.

There is no particular restriction as to the shape and size of the fillers. Spherical silica or amorphous silica may be used as the filler. The particle size of the silica may be about 5 nm to about 20 μm.

The fillers may be present in an amount of about 1 wt % to about 30 wt %, e.g., about 5 wt % to about 25 wt %, based on the total weight of the adhesive composition in terms of solid content. Within this range of the fillers, the adhesive composition may exhibit high flowability, film formability, and adhesion.

### Solvent

The adhesive composition may further include a solvent. The solvent may help reduce the viscosity of the adhesive composition, thereby facilitating formation of an adhesive film. Examples of solvents may include organic solvents such as toluene, xylene, propylene glycol monomethyl ether acetate, benzene, acetone, methylethylketone, tetrahydrofuran, dimethylformamide, and cyclohexanone.

Another embodiment relates to an adhesive film for semiconductors that is prepared from the adhesive composition described above. There is no need for a special apparatus or equipment for forming an adhesive film for semiconductors using the adhesive composition according to an embodiment, and a suitable method may be used to manufacture the adhesive film. For example, the respective components may be dissolved in a solvent, and sufficiently kneaded using a bead-mill, followed by depositing the resultant on a polyethylene terephthalate (PET) release film, and drying in an oven at 100° C. for about 10˜30 minutes to prepare an adhesive film having a suitable thickness.

In an implementation, the adhesive film for semiconductors may include a base film, a photo-sensitive adhesive layer, an adhesive layer, and a protective film, which are sequentially stacked in this order.

The adhesive film may have a thickness of about 5 μm to about 200 μm, e.g., about 10 μm to about 100 μm. Within this range, the adhesive film may exhibit sufficient adhesion while providing economic feasibility. In an implementation, the adhesive film may have a thickness of about 15 μm to about 60 μm.

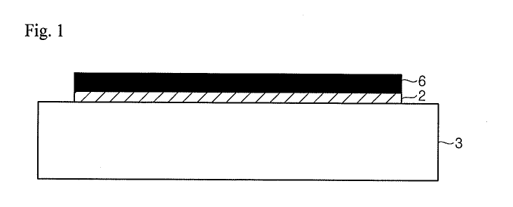

FIG. 1 illustrates a side sectional view of a semiconductor device in which a semiconductor chip is on an adhesive layer. Referring to FIG. 1, the semiconductor device may include a substrate 3, an adhesive layer 2 on the substrate 3, and a semiconductor chip 6 on the adhesive layer 2.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### EXAMPLES

### Examples 1-2

### Preparation of Adhesive Composition for Semiconductors

A solvent (cyclohexanone) was added to a thermoplastic resin, an epoxy resin, a phenolic curing agent, an amine curing resin, a curing accelerator, fillers, and a silane coupling agent, as listed in Table 1, below, such that the solid content in the solution was 20% by weight, followed by sufficiently kneading the components using a bead-mill, thereby preparing an adhesive composition for semiconductors.

### Comparative Examples 1-3

### Preparation of Adhesive Composition for Semiconductors

Adhesive compositions for semiconductor were prepared in the same manner as in Examples 1 and 2, except for including components as listed in Table 1.

Details of respective components used in Examples and Comparative Examples are shown in Table 1.

TABLE 1

| | | | Comparative | Comparative | Comparative |
|---|---|---|---|---|---|
| □ | Example 1 | Example 2 | Example 1 | Example 2 | Example 3 |
| (a) Thermoplastic resin⁽¹⁾ | 70 | 70 | 70 | 70 | 70 |
| (b) Epoxy resin⁽²⁾ | 10 | 10 | 10 | 10 | 10 |
| (c) Phenolic curing agent⁽³⁾ | 4.5 | 4.5 | 9 | — | 4.5 |
| (d) Amine curing agent⁽⁴⁾ | 4.5 | 4.5 | — | 9 | 4.5 |
| Silane coupling agent⁽⁵⁾ | 1 | 1 | 1 | 1 | 1 |
| Curing accelerator⁽⁶⁾ | 0.5 | 1 | 1 | 1 | 0.5 |
| Fillers⁽⁷⁾ | 8.5 | 8.5 | 8.5 | 8.5 | 9.5 |
| Colorant fillers⁽⁸⁾ | 1.0 | 0.5 | 0.5 | 0.5 | — |
| (a):(b) + (c) + (d) | 70:19 | 70:19 | 70:19 | 70:19 | 70:19 |
| Total (total weight) | 100 | 100 | 100 | 100 | 100 |

⁽¹⁾Thermoplastic resin: SG-P3 (Nagase Chemtex Co., Ltd.)
⁽²⁾Epoxy resin: YDCN-500-90P (Kukdo Chemical Co., Ltd.)
⁽³⁾Phenolic curing agent: HF-1M (Eq.: 106, Meiwa Chemicals Co., Ltd.)
⁽⁴⁾Amine curing agent: DDM (Tokyo Chemical Ind.)
⁽⁵⁾Silane coupling agent: KBM-403 (Shinetsu Co., Ltd.)
⁽⁶⁾Curing accelerator: TPP (HOKKO Chemical Industry Co., Ltd.)
⁽⁷⁾Fillers: R-972 (Degussa GmbH)
⁽⁸⁾Colorant fillers: KA-100 (Cosmo Chemicals Co., Ltd.)
(9) Organic solvent: Cyclohexanone

### Preparation of Adhesive Film

Each of the adhesive compositions prepared in Examples 1 and 2 and Comparative Examples 1, 2, and 3 was deposited on a PET release film using an applicator, followed by drying in an oven at 100° C. for 10˜30 minutes, thereby providing an adhesive film having a 5 μm thick adhesive layer. In addition, an adhesive film having a 10 μm thick adhesive layer and having the same composition as Example 1 was prepared as Example 3.

### Experimental Example

### Evaluation of Physical Properties of Adhesive Composition and Adhesive Film Prepared in Examples and Comparative Examples

Physical properties of each of the adhesive compositions or adhesive films prepared using the same in Examples 1 to 3 and Comparative Examples 1, 2, and 3 were evaluated by the following methods, and results are shown in Table 2, below.

TABLE 2

| | | | | | | Comparative | Comparative | Comparative |
|---|---|---|---|---|---|---|---|---|
| Content | Conditions | Unit | Example 1 | Example 2 | Example 3 | Example 1 | Example 2 | Example 3 |
| Die-shear | 260° C. | Kgf/chip | 2.5 | 2.4 | 2.8 | 3.0 | 0.6 | 2.5 |
| strength | | | | | | | | |
| Haze | | % | 28 | 25 | 33 | 24 | 25 | 11 |
| Storage | 175° C. | 10⁶ dyne/cm² | 3.2 | 2.7 | 3.2 | 4.4 | 1.6 | 2.8 |
| modulus after | | | | | | | | |
| 1 cycle (A) | | | | | | | | |
| Storage | 175° C. | 10⁶ dyne/cm² | 4.4 | 4.3 | 4.4 | 8.2 | 3.2 | 4.5 |
| modulus after | | | | | | | | |
| 4 cycles (B) | | | | | | | | |
| B − A | | 10⁶ dyne/cm² | 1.2 | 1.6 | 1.2 | 3.8 | 1.6 | 1.7 |
| Void area after | | % | 4 | 5 | 2 | 25 | 2 | 6 |
| 4 cycles | | | | | | | | |
| Reflow | | % | 0/10 | 0/10 | 0/10 | 4/10 | 0/10 | 0/10 |
| resistance | | | | | | | | |
| (fail/total) | | | | | | | | |
| Recognition | | % | Recognized | Recognized | Recognized | Recognized | Recognized | Unrecognized |

(1) Die-shear strength: A 530 μm thick wafer was cut into chips having a size of 5×5 mm. The chips were laminated with each of the adhesive films at 60° C., and were cut to leave behind a bonded portion only. An upper chip having a size of 5×5 mm was placed on a wafer having a size of 10×10 mm, followed by application of a load of 10 kgf to the chip on a hot plate at 120° C. for 5 seconds and curing in an oven at 175° C. for 1 hour. Then, the die-shear strength was measured (tester: DAGE 4000, hot plate temperature: 260° C.). Results are shown in Table 2.

(2) Haze: Intensities of transmitted light and diffusive light of the adhesive were measured using a Halogen lamp to obtain the haze value as a percentage of diffusive light to total transmittance light (transmitted light+diffusive light) of the adhesive layer.

(3) Storage modulus: Several sheets of adhesive films were stacked at 60° C. and cut into a circular sample having a diameter of 8 mm (thickness: about 400 μm to 450 μm). Then, each sample was subjected to curing in an oven at 125° C. for 1 hour and on a hot plate at 150° C. for 10 minutes (i.e., 1 cycle). Then, the storage modulus of each sample was measured using a rheometer (ARES) while increasing the temperature from 30° C. to 200° C. The storage modulus at 170° C. is shown in Table 2. Here, the temperature increase rate was 10° C./min. Storage modulus after 4 cycles was measured using a rheometer (ARES) after repeating the process of curing in an oven at 125° C. for 1 hour and on a hot plate at 150° C. for 10 minutes four (4) times.

(4) Void area after 4 cycles: The adhesive film for semiconductors was mounted on a 80 μm thick wafer, and cut to a specimen having a size of 10 mm×10 mm. Then, the specimen was attached to a PCB at 120° C. and 1 kgf/sec, and subjected to curing in an oven at 125° C. for 1 hour and on a hot plate at 150° C. for 10 minutes (1 cycle). This cycle was repeated 4 times to apply heat for 4 cycles, followed by molding using EMC (8500BCA, Cheil Industries, Inc.) at 175° C. for 120 seconds. The adhesive layer of the adhesive film was exposed and photographed using a microscope (magnification: x25), and the presence of voids was inspected through image analysis. To digitize the number of voids, a lattice counting method was used. Specifically, the total area of the sample was divided into 10 lattice rows and 10 lattice columns, and the number of lattices including voids was counted and converted into % (void area ratio).

Void area ratio=(void area/total area)×100

(5) Reflow resistance: The prepared adhesive film was mounted on an 80 μm thick wafer, and cut into a specimen having a size of 10 mm×10 mm. Then, the specimen was attached to a PCB at 120° C. and 1 kgf/sec, and subjected to curing in an oven at 125° C. for 1 hour and on a hot plate at 150° C. for 10 minutes (1 cycle). This cycle was repeated 4 times to apply heat for 4 cycles, followed by molding using EMC (8500BCA, Cheil Industries, Inc.) at 175° C. for 120 seconds. The prepared specimen was left under conditions of 85° C./85% RH for 168 hours, and subjected to reflow 3 times at a maximum temperature of 260° C., followed by observation of cracking using SAT.

(6) Recognition: The prepared adhesive film was passed through an optical sensor of a rewinding machine (PNT) (line speed: 7 mpm, unwinder tension: 20 N, rewinder tension: 22N). When the sensor sensed the adhesive film, the film was evaluated as being recognized, and when the sensor failed to sense the adhesive film, the film was evaluated as being unrecognized.

As shown in Table 2, it may be seen that the adhesive compositions of Examples 1 to 3 allowed for good equipment recognition and exhibited a die-shear strength of 1 kgf/chip or more after 1 cycle to provide sufficient strength for wire bonding. The adhesive composition of Comparative Example 2 exhibited good void removal characteristics, but exhibited a die-shear strength of less than 1 kgf/chip, causing bonding failure upon wire bonding. Further, the adhesive compositions of Examples 1 to 3 had a storage modulus 7×10⁶ dyne/cm² or less after 4 cycles. The adhesive composition of Comparative Example 1 had a storage modulus of greater than 7×10⁶ dyne/cm² after 4 cycles, and a void area ratio of 25% upon molding due to insufficient flowability by excessive curing, which may result in a deterioration in reliability. The adhesive composition of Comparative Example 3 did not include the colorant fillers and exhibited insufficient equipment recognition capabilities.

By way of summation and review, high capacity of a semiconductor device may be achieved by circuit integration, in terms of quality, in which the number of cells per unit area is increased, or by packaging, in terms of quantity, in which chips are stacked one above another.

As such a packaging method, multi-chip packaging (hereinafter “MCP”) may be used, and may have a structure in which a plurality of chips is stacked one above another via adhesives such that upper and lower chips may be electrically connected to each other by wire bonding.

To help ensure sufficient bonding strength between chips and a printed circuit board (PCB) in a chip-bonding process, a PCB baking process and a PCB plasma process may be performed. In addition, after completion of chip bonding at 120° C. for a few seconds, a curing process (or semi-curing process or B-stage process) may be performed for 1 hour or more to provide sufficient bonding strength upon wire bonding. After completion of wire bonding at 150° C. for 2 to 20 minutes, epoxy molding (EMC Molding) and post-mold curing (PMC) may be sequentially performed. For example, PMC may be performed at 175° C. for about 2 hours.

The PCB baking process, PCB plasma process, curing process (or semi-curing process, or B-stage process) and post molding curing process may all be individually performed and may be difficult to reduce in duration and number of workers, thereby resulting in a deterioration in productivity.

To help improve productivity in manufacture of semiconductors, an in-line process wherein chip bonding and wire bonding are successively performed while a PCB is transferred on a rail may be desirable. In addition, a novel adhesive film for semiconductors may be applicable to the in-line process. For example, in the in-line process, a thermal procedure for allowing an adhesive layer to form a sufficient crosslinking structure may be significantly reduced. Thus, a composition, which allows rapid curing even under the condition that the curing process (or semi-curing or B-stage process) and/or the PMC process are omitted or curing process time is reduced, may be desirable, such that bonding failure, chip separation and deterioration in reliability may not occur during wire bonding.

In some cases, an adhesive film having a 20 μm thick adhesive layer may be used due to surface steps of the PCB. However, in order to satisfy continuous demand for package thickness reduction, an adhesive film including an adhesive layer having a thickness of 15 μm or less may be desirable. However, when the thickness of the adhesive layer is less than or equal to 15 μm, equipment recognition may deteriorate due to an increase in transparency of the adhesive layer. Thus, an adhesive film that may help secure equipment recognition capabilities even at a thickness of 15 μm or less, is applicable to chip-to-chip and chip-to-PCB processes, and allows multi-layer stacking, may be desirable.

When applied to multi-layer stacking, some adhesive compositions may not secure sufficient flowability upon repeated heating and thus may not allow efficient removal of voids upon molding process.

The adhesive composition for semiconductors according to an embodiment may be applied to an in-line process by shortening a curing process (or semi-curing process, or B-stage process) after chip bonding, thereby improving efficiency and productivity in semiconductor manufacture.

In addition, the adhesive composition and adhesive film for semiconductors according to embodiments of the invention may provide satisfactory processability and reliability by securing sufficient flowability with low viscosity and storage modulus for repeated heating cycles upon multi-layer stacking.

Further, the adhesive film for semiconductors according to an embodiment may provide good equipment recognition to a thin film type adhesive film.

The embodiments may provide an adhesive film for a semiconductor that helps improve productivity in a semiconductor manufacturing process.

Another embodiment may provide an adhesive composition for a semiconductor that can be applied to an in-line process by exhibiting sufficient adhesion and elasticity, even when a curing process (or semi-curing process, or B-stage process) is shortened after chip bonding.

Another embodiment may provide a thin film type adhesive film applicable to multi-layer stacking.

Another embodiment may provide a thin film type adhesive film having improved equipment recognition capabilities.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An adhesive film for semiconductors, wherein:
a difference between a storage modulus (A) of the adhesive film after 4 cycles and a storage modulus (B) of the adhesive film after 1 cycle is about 3×10⁶ dyne/cm² or less,
the storage modulus (A) of the adhesive film after 4 cycles is about 7×10⁶ dyne/cm² or less, and
the storage modulus (B) of the adhesive film after 1 cycle is about 2×10⁶ dyne/cm² or more, when curing at 125° C. for 1 hour and then at 150° C. for 10 minutes is defined as 1 cycle.

2. The adhesive film as claimed in claim 1, wherein the adhesive film has a die-shear strength of about 1 kgf/5×5 mm² chip or more at 260° C. after curing in an oven at 175° C. for 1 hour.

3. The adhesive film as claimed in claim 1, wherein the adhesive film has a void area ratio of about 10% or less after 4 cycles.

4. The adhesive film as claimed in claim 1, wherein the adhesive film has a haze value of about 20% or more.

5. The adhesive film as claimed in claim 1, wherein the adhesive film includes a colorant filler.

6. The adhesive film as claimed in claim 1, wherein the adhesive film includes an adhesive layer having a thickness of about 5 μm to about 15 μm.

7. The adhesive film as claimed in claim 1, wherein the adhesive layer includes:
a thermoplastic resin,
an epoxy resin,
a phenolic curing agent,
an amine curing agent,
a curing accelerator, and
a colorant filler.

8. The adhesive film as claimed in claim 7, wherein the adhesive layer includes:
about 51 wt % to about 80 wt % of the thermoplastic resin;
about 5 wt % to about 20 wt % of the epoxy resin;
about 2 wt % to about 10 wt % of the phenolic curing agent;
about 2 wt % to about 10 wt % of the amine curing agent;
about 0.1 wt % to about 10 wt % of the curing accelerator; and
about 0.05 wt % to about 5 wt % of the colorant filler, all wt % being based on a total weight of the adhesive film in terms of solid content.

9. The adhesive film as claimed in claim 7, wherein a weight ratio of a weight of the thermoplastic resin to a weight of a mixture of the epoxy resin, the phenolic curing agent, and the amine curing agent is about 51-80:9-40.

10. The adhesive film as claimed in claim 7, wherein the amine curing agent is an aromatic amine curing agent.

11. The adhesive film as claimed in claim 10, wherein the aromatic amine curing agent is represented by Formula 1, below, 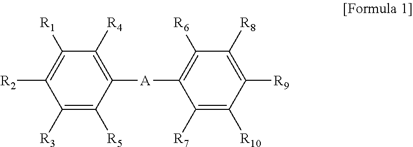
wherein, in Formula 1:
A is a single bond or is selected from the group of —CH₂—, —CH₂CH₂—, —SO₂—, —NHCO—, —C(CH₃)₂—, and —O—; and
R₁ to R₁₀ are each independently selected from hydrogen, a C₁-C₄ alkyl group, a C₁-C₄ alkoxy group, or an amine group, provided that at least two of R₁ to R₁₀ are amine groups.

12. The adhesive film as claimed in claim 7, wherein the phenolic curing agent is represented by Formula 6, below, 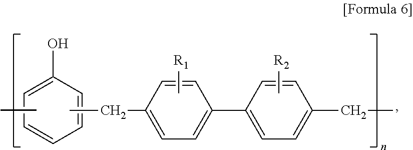
wherein, in Formula 6, R₁ and R₂ are each independently a C₁-C₆ alkyl group and n is about 2 to about 100.

13. The adhesive film as claimed in claim 7, wherein the curing accelerator includes at least one of an imidazole curing accelerator or a microcapsule type latent curing agent.

14. The adhesive film as claimed in claim 7, wherein the colorant filler is an inorganic or organic pigment of a red, blue, green, yellow, violet, orange, brown, or black color.

15. The adhesive film as claimed in claim 1, wherein the adhesive film is for attaching a chip to a PCB (printed circuit board) or attaching two chips different in size to each other.

16. A semiconductor device connected using the adhesive film for semiconductors as claimed in claim 1.
